(19) United States
(12) Patent Application Publication
(10) Pub. No.: US 2004/0104967 A1
(43) Pub. Date: Jun. 3, 2004

(54) Ink-jet printhead

(75) Inventors: Kwang-ryul Kim, Gyconggi-do (KR); Sang-cheol Ko, Gyeonggi-do (KR); Jong-suk Seo, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/617,252

(22) Filed: Jul. 11, 2003

(30) Foreign Application Priority Data
Jul. 15, 2002 (KR) 2002-41243

(51) Int. Cl. B41J 2/14

(52) U.S. Cl. 347/50

(57) ABSTRACT

An ink-jet printhead comprising a substrate which includes an ink chamber where ink is stored, nozzles through which ink in the ink chamber is ejected, and a plurality of pads which apply an electrical signal to generate droplets in the ink chamber, a flexible printed circuit (FPC) cable which includes a conductor corresponding to each of the pads, each conductor having bonding portions at front ends thereof, and connection members which electrically connect the pads to the bonding portions.

### CROSS-REFERENCE TO RELATED APPLICATIONS

This application claims the priority of Korean Patent Application No. 2002-41243, filed on Jul. 15, 2002, in the Korean Intellectual Property Office, the disclosure of which is incorporated herein in its entirety by reference.

### BACKGROUND OF THE INVENTION

1. Field of the Invention

The present invention relates to an ink-jet printhead having a flexible printed circuit (FPC) cable.

2. Description of the Related Art

Ink-jet printheads, which use an electro-thermal transducer method, which ejects ink droplets by the expansion force of bubbles generated in ink by instantaneously heating ink, include a substrate on which a heater and nozzles are formed. A plurality of signal lines that are electrically connected to the heater, and a plurality of electrical pads that are arranged in an in-line shape at edges of the substrate so as to connect the plurality of signal lines to an external circuit are formed on the substrate.

The pads are connected to a flexible printed circuit (FPC) cable in which a plurality of conductors respectively corresponding to the electrical pads are arranged parallel to one another. Connecting the pads to the conductors is performed by thermosonic bonding.

U.S. Pat. Nos. 4,635,073 and 6,126,271 disclose methods to connect pads to conductors by thermosonic bonding. Thermosonic bonding is a single point bonding method. Thus, as shown in FIG. 1, a conductor 3 is in contact with a pad 2 formed on a substrate 1, and then, a thermosonic bonding tool 4 is placed in contact with the conductor 3. In this state, one pad 2 and one conductor 3 can be sequentially bonded to each other by one bonding. Thus, according to conventional thermosonic bonding methods, bonding has to be sequentially and repeatedly performed as many times as the number of pads, and as a result, it takes added time to bond an FPC cable to one substrate.

Also, in thermosonic bonding, a bonding tool is locally in contact with a conductor during a bonding process. Thus, abnormal deformation may occur in a contact portion where an oscillation energy caused by ultrasonic waves is concentrated. As a result, the stiffness of a bonding portion is lowered, and the conductor may be easily detached from the pad.

### SUMMARY OF THE INVENTION

The present invention provides an ink-jet printhead having an improved structural stiffness in a bonding portion between a conductor and a pad of a flexible printed circuit (FPC).

The present invention also provides an ink-jet printhead which improves a printing quality by reducing an interlace distance of ink droplets.

According to an aspect of the present invention, an ink-jet printhead comprises a substrate which includes an ink chamber where ink is stored, nozzles through which ink in the ink chamber is ejected, and a plurality of pads which apply an electrical signal to generate droplets in the ink chamber; a flexible printed circuit (FPC) cable which includes a conductor corresponding to each of the pads, each conductor having bonding portions at front ends thereof; and connection members which electrically connect the pads to the bonding portions.

In an embodiment of the invention, the FPC includes a protection layer to protect the conductor. An opening through which the bonding portions are exposed is provided in the protection layer.

In an embodiment of the invention, one end of each pad of the substrate and one end of each connection member are bonded to each other by hot pressure welding or soldering. Further, the other end of each bonding portion of the FPC and the other end of each connection member are bonded to each other by hot pressure welding or soldering.

In an embodiment of the invention, one end of each pad of the substrate and one end of each connection member and the other end of each bonding portion of the FPC and the other end of each connection member are respectively bonded to one another by hot pressure welding.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments taken in conjunction with the accompanying drawings in which:

FIG. 1 illustrates a conventional method to bond a flexible printed circuit (FPC) cable of an ink-jet printhead by thermosonic welding;

FIG. 2 is a plan view illustrating an arrangement state of an FPC and a substrate of an ink-jet printhead according to an embodiment of the present invention;

FIG. 3 is an enlarged plan view partially showing a substrate of the ink-jet printhead shown in FIG. 2 and an FPC around the substrate, according to the present invention;

FIG. 4 is a cross-sectional view illustrating the ink-jet printhead according to a first embodiment of the present invention;

FIG. 5 is a cross-sectional view illustrating the ink-jet printhead according to a second embodiment of the present invention;

FIG. 6 is a cross-sectional view illustrating the ink-jet printhead according to a third embodiment of the present invention;

FIG. 7 illustrates an example of a connection member used in the ink-jet printhead according to an embodiment of the present invention;

FIG. 8 is an extracted perspective view illustrating a bonding tool used to assemble of the ink-jet printhead according to an embodiment of the present invention;

FIG. 9 illustrates a welding method using the bonding tool shown in FIG. 8;

FIG. 10 shows an FPC used in the ink-jet printhead according to an embodiment of the present invention, the photos being taken in the state where the magnification of a top left photo is gradually reduced;

FIG. 11 is a plan view illustrating the state where the connection member is welded to a bonding portion of the FPC and a pad of the substrate according to an embodiment of the present invention;

FIG. 12 is a plan view illustrating portions welded by the bonding tool according to an embodiment of the present invention and by a conventional thermosonic method, respectively; and

FIG. 13 shows the state where the connection member is forcibly separated from each of the welded portions by hot pressure welding according to an embodiment of the present invention and by ultrasonic waves as in the conventional method, respectively.

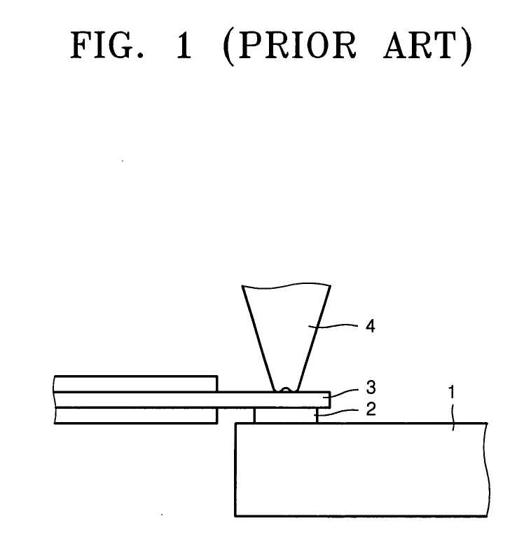

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

The present invention uses hot pressure welding or soldering, instead of thermosonic bonding, performed using local kinetic energy, i.e., thermosonic welding. In hot pressure welding or soldering, an oscillation shock is not applied to a fragile substrate. Hot pressure welding is performed by a bonding tool that can be instantaneously heated by a fine resistor. An additional conductor electrically connects a flexible printed circuit (FPC) and a substrate of the ink-jet printhead.

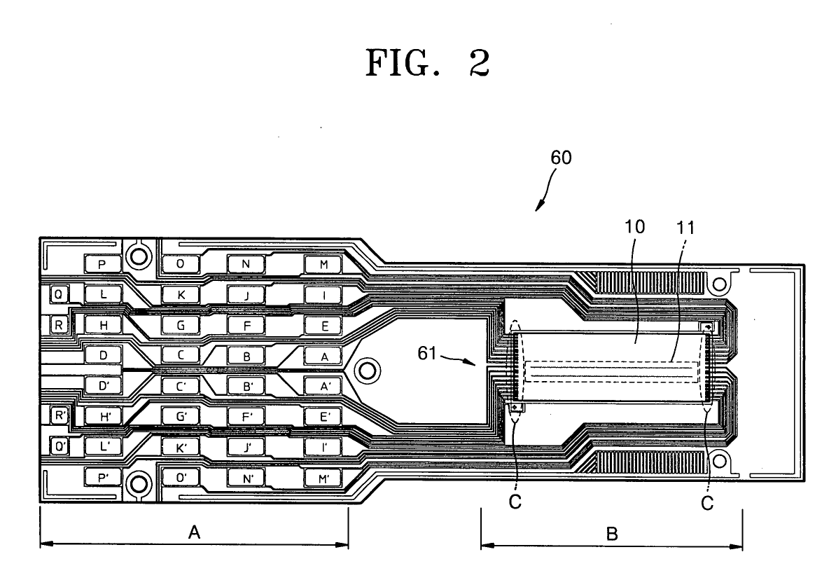

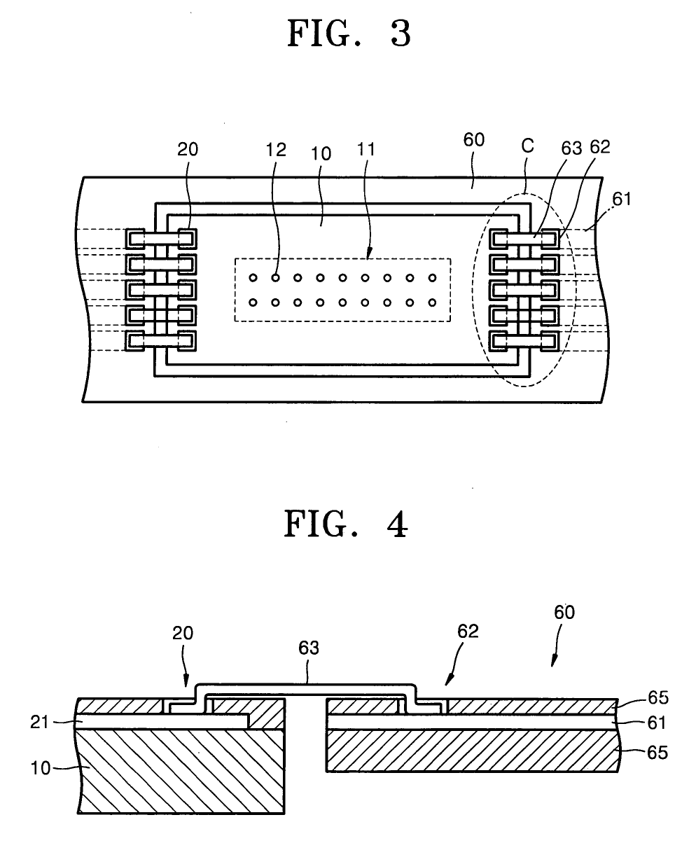

FIG. 2 is a plan view illustrating an FPC cable 60 and a substrate 10 connected to the FPC cable 60, both of an ink-jet printhead according to the present invention. FIG. 3 is an enlarged plan view schematically illustrating the substrate 10. As shown in FIG. 2, the FPC cable 60 includes a pad region A and a bonding region B. A plurality of contact pads (marked with alphabet letters) are provided in the pad region A and contact terminals (not shown) are provided in a head transfer tool of a printer. A conductor 61, electrically connected to a pad (see 20 of FIG. 3) of the substrate 10 of the ink-jet printhead is arranged in the bonding region B. In FIG. 2, reference numeral 11 marked in the substrate 10 denotes a region in which nozzles 12 are formed, as shown in FIG. 3. As shown in FIG. 3, bonding portions 62 in a front end portion of the conductor 61 are arranged in a region C which corresponds to a single side of the substrate 10.

As shown in FIGS. 2 and 3, the FPC cable 60 is arranged to surround the substrate 10 of the ink-jet printhead. As shown in FIG. 3, an ink chamber under a nozzle and a heater (not shown), as well as the nozzles 12 arranged in two rows, are provided on the substrate 10. Bonding pads 20 electrically connected to the heater through internal signal lines are arranged at edges of the single side of the substrate 10. The bonding pads 20 and the bonding portions 62, of each conductor 61 of the FPC cable 60 corresponding to the bonding pads 20, are respectively connected by additional connection members 63. In the drawings, the nozzles 12 are arranged in two rows but may be arranged in three or more rows so as to improve printing resolution.

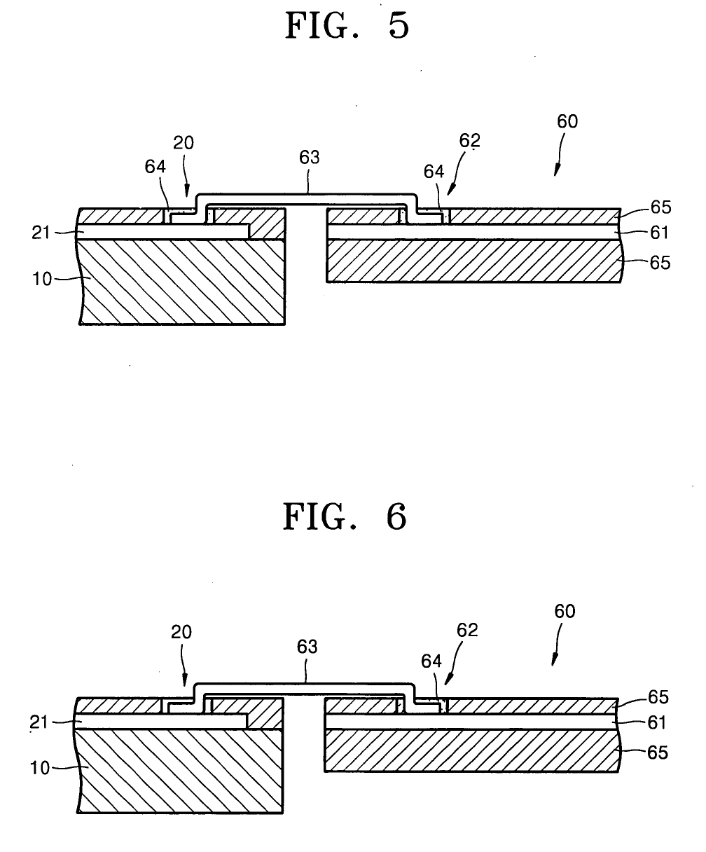

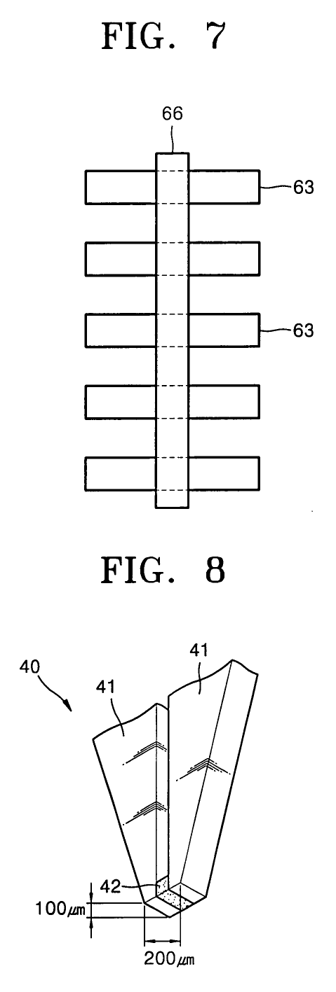

FIGS. 4 and 5 are cross-sectional views illustrating a connection structure between the bonding pads 20 provided on an end of the conductor 21 of the substrate 10 through the connection members 63, and the bonding portions 62 of the FPC cable 60. The conductor 61 of the FPC cable 60 is protected by upper and lower protection layers 65. An opening through which the front end of the conductor 61 is exposed is formed in the upper protection layer 65. The front end of the conductor 61 exposed through the opening formed in the upper protection layer 65 corresponds to the above-described bonding portions 62. FIG. 4 illustrates the state where the connection members 63 are bonded by melting the bonding pads 20 of the substrate 10 and the bonding portion 62 of the FPC cable 60, and FIG. 5 illustrates the state where the bonding pads 20 of the substrate 10 and the bonding portions 62 of the FPC 60 are bonded using additional solder 64. Also, FIG. 6 illustrates the state where the bonding pads 20 and the connection members 63 are welded by hot pressure welding and the connection members 63 and the bonding portions 62 are bonded by the solder 64.

The connection members 63 are supplied in a ribbon shape so that a so-called tape automated bonding (TAB) process of the FPC cable 60 can be performed. The bonding portions 62 and the opening through which the bonding portions 62 are exposed have been already formed on the substrate 10. The opening may be processed by an excimer laser. Here, in order to minimize melting of a processed surface, the opening is processed by varying the pulse of the laser. Also, a processing state is made better using an interruptive method, for example, by changing a pulse cycle or adjusting a time interval of pulse. Meanwhile, in case of a laser except for the excimer laser, it is easy to focus a laser light. Thus, a groove connection portion may be processed using different focus spot sizes and a variation in fluence (the amount of an energy per unit area) of a laser light, instead of using a mask. In addition, the connection members 63 may be perforated using a mechanical fine perforator as well as laser ablation.

The connection members 63 may be supplied to be fixed parallel to one another by one insulating connection ribbon 66. The width of each connection member 63 is about 100 microns, and its thickness is about 30 microns. In FIGS. 4 and 5, both ends of each connection member 63 are formed in a stair shape. However, these stair portions may be formed to be flat (not indented) as occasion demands.

As shown in FIG. 5, when the connection members 63 are bonded to the pads 20 and the bonding portions 62 by the solder 64, known processes of supplying cream solder, mounting the connection members 63, and melting and hardening the solder 64 are performed.

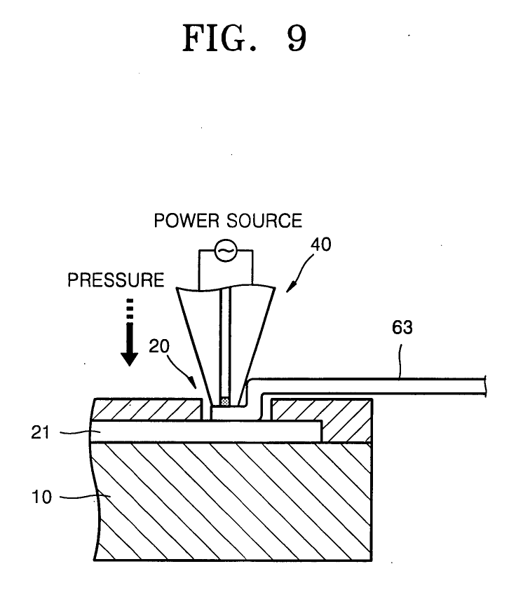

Meanwhile, as shown in FIG. 4, when the connection members 63 are directly fused on the pads 20 and the bonding portions 62, as shown in FIG. 8, a bonding tool 40 using a thermal pressing method is used. As shown in FIG. 8, the bonding tool 40 includes conductive pressing tips 41 maintaining a predetermined gap and an electrical heating layer 42 provided between front ends of the conductive pressing tips 41. The conductive pressing tips 41 serve to press a welding object and as a path through which the electrical heating layer 42 therebetween supplies current. The width of the front end of each conductive pressing tip 41 including the electrical heating layer 42 is about 200 microns, and the thickness of each conductive pressing tip 41 is about 100 microns. The electrical heating layer 42 is formed of a high resistance material such as tungsten. For example, the electrical heating layer 42 instantaneously generates heat having a temperature of 300 to 500° C. under a low voltage of about 0.5 volt. Welding of the connection members 63 using the bonding tool 40 is performed by a general hot pressure method welding as shown in FIG. 9. In hot pressure welding, welding is performed on one pad at a time.

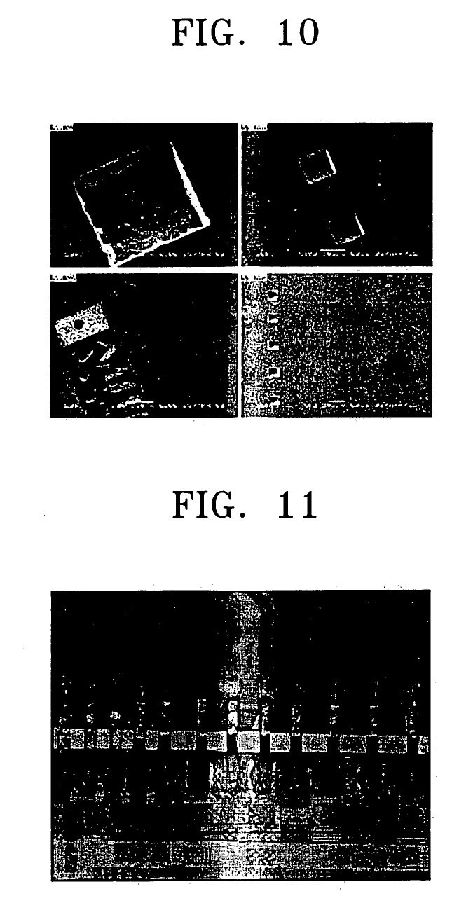

FIG. 10 shows an FPC in which the opening is processed by a laser, the photos being taken in the state where the magnification of a top left photo is gradually reduced.

FIG. 11 is a plan view illustrating the state where the connection member is welded to a bonding portion of the FPC and a pad of the substrate according to the present invention. Here, the connection members are bonded by soldering instead of hot pressure welding. In FIG. 11, a bright portion in a horizontal direction represents a gap between the substrate and the FPC, and its lower portion is the substrate, and its upper portion is the FPC.

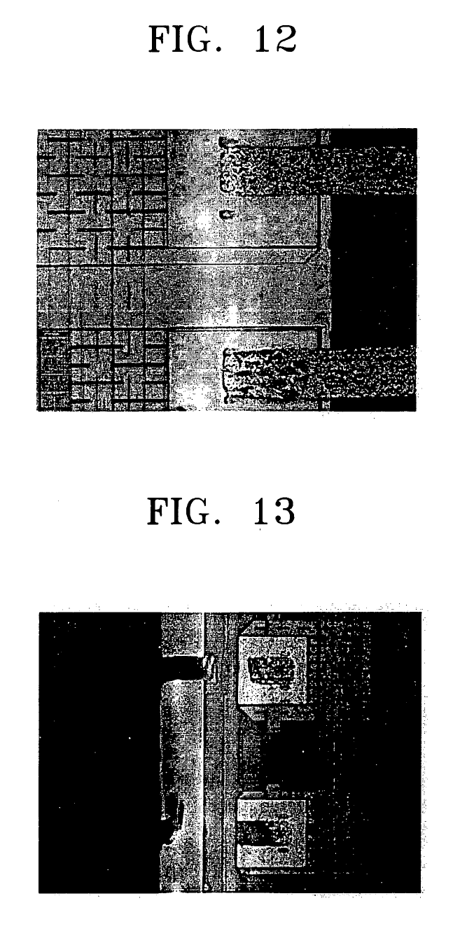

FIG. 12 shows portions welded by the bonding tool according to the present invention and by a conventional thermosonic method, respectively. An upper portion of FIG. 12 is a portion welded by hot pressure welding, and a lower portion of FIG. 12 is a portion welded by thermosonic welding. As shown in FIG. 12, traces formed by ultrasonic tips remain in the lower portion welded by thermosonic welding . The upper portion welded by the bonding tool, according to the present invention, is maintained in a slippery state.

FIG. 13 shows the state where the connection member is forcibly separated from each of the welded portions by hot pressure welding according to the present invention and by ultrasonic waves as in the conventional method, respectively. An upper portion of FIG. 13 is a portion welded by hot pressure welding according to the present invention, and a welded portion of the connection members is attached to pads by very strong welding, and a backward neck portion thereof is disconnected. In addition, a lower portion of FIG. 13 is a portion welded by ultrasonic waves, and the connection members are completely separated from the pads. Thus, according to the present invention, the connection members are welded by hot pressure welding with a very strong stiffness.

As described above, the ink-jet printhead disclosed in the present invention uses additional connection members and hot pressure welding to directly bond a conductor exposed from an FPC cable to pads on a substrate. Consequently, an electrical failure due to pad peel-off caused by direct bonding between the conductor and the pads is prevented, thereby improving bonding reliability.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An ink-jet printhead comprising:
a substrate which includes an ink chamber where ink is stored, nozzles through which ink in the ink chamber is ejected, and a plurality of pads which apply an electrical signal to the substrate to generate droplets in the ink chamber;
a flexible printed circuit (FPC) cable which includes a conductor corresponding to each of the pads, each conductor having bonding portions at front ends thereof; and
connection members which electrically connect the pads to the bonding portions.

2. The printhead of claim 1, wherein the FPC includes a protection layer, protecting the conductor, having an opening through which the bonding portions are exposed is provided in the protection layer.

3. The printhead of claim 1, wherein one end of each pad of the substrate and one end of each connection member are bonded to each other by hot pressure welding or soldering.

4. The printhead of claim 1, wherein ends of the bonding portions of the FPC and the other end of each connection member are bonded to each other by hot pressure welding or soldering.

5. The printhead of claim 1, wherein each connection member is bonded to one end of each pad of the substrate and ends of the bonding portions of the FPC by hot pressure welding.

6. The printhead of claim 2, wherein one end of each pad of the substrate and one end of each connection member are bonded to each other by hot pressure welding or soldering.

7. The printhead of claim 2, wherein ends of the bonding portions of the FPC and the other end of each connection member are bonded to each other by hot pressure welding or soldering.

8. The printhead of claim 2, wherein each connection member is bonded to one end of each pad of the substrate and ends of the bonding portions of the FPC by hot pressure welding.

9. An ink-jet printhead, comprising:
a substrate including a first conductor having a bonding pad;
a Flexible Printed Circuit (FPC) having a second conductor having a bonding portion corresponding to the bonding pad; and
a connection member, wherein the connection member electrically connects the bonding pad of the first conductor to the bonding portion of the second conductor, and
the connection member is bonded to the bonding pad by hot pressure welding.

10. The ink-jet printhead according to claim 9, wherein the connection member is bonded to the bonding pad and the bonding portion by hot pressure welding.

11. The ink-jet printhead according to claim 10, wherein the hot pressure welding employs a bonding tool and a thermal pressing method.

12. The ink-jet printhead according to claim 9, wherein the FPC comprises a cable surrounding the substrate.

13. The ink-jet printhead according to claim 9, further comprising nozzles on the substrate.

14. The ink-jet printhead according to claim 9, further comprising upper and lower protection layers protecting the second conductor.

15. The ink-jet printhead according to claim 14, further comprising an opening in the upper protection layer through which the bonding portion is exposed.

16. The ink-jet printhead according to claim 9, wherein the connection member is substantially ribbon shaped.

17. The ink-jet printhead according to claim 9, wherein the connection member is perforated.

18. The ink-jet printhead according to claim 9, further comprising a plurality of connection members.

19. The ink-jet printhead according to claim 28, further comprising an insulating connection ribbon to fix the plurality of connection members in a parallel arrangement.

20. A method of fusing a connection member to a bonding pad of a substrate, comprising:
opening an opening in a protective layer above the bonding pad of the substrate; and
hot pressure welding the connection member to the bonding pad of the substrate.

21. The method according to claim 20, further comprising hot pressure welding the connection member to a bonding portion of a Flexible Printed Circuit (FPC).

22. The method according to claim 21, further comprising soldering the connection member to the bonding pad of the substrate and the bonding portion of the FPC.

23. The method according to claim 21, wherein the operation of opening comprises processing by an excimer laser.

24. The method according to claim 23, wherein the processing further comprises varying a pulse of the laser to prevent melting.

25. The method according to claim 23, wherein the processing further comprises using an interruptive method, the interruptive method comprising:
changing a pulse cycle of the laser; and
adjusting a time interval of the pulse of the laser.

26. The method according to claim 20, wherein the hot pressure welding comprises:
pressing a bonding tool on a welding object; and
heating an electrical heating layer in a gap at an end of the bonding tool to approximately 300-500 degrees celcius.
